(19) United States
(12) Patent Application Publication
(10) Pub. No.: US 2024/0019857 A1
(43) Pub. Date: Jan. 18, 2024

(54) ESTIMATION DEVICE, ESTIMATION METHOD, AND RECORDING MEDIUM

(71) Applicant: NEC Corporation, Minto-ku, Tokyo (JP)

(72) Inventors: Takashi ONISHI, Tokyo (JP); Shumpei KUBOSAWA, Tokyo (JP)

(73) Assignee: NEC Corporation, Minto-ku, Tokyo (JP)

(21) Appl. No.: 18/037,462

(22) PCT Filed: Nov. 27, 2020
(86) PCT No.: PCT/JP2020/044177

§ 371 Date: May 17, 2023

(51) Int. Cl. G05B 19/418

(52) U.S. Cl. CPC G05B 19/41875; G05B 19/4183

(57) ABSTRACT

An estimation device determines a state estimation target portion of a monitoring target based on qualitative inference that uses designated portion qualitative expression information qualitatively indicating a state of a designated portion of the monitoring target, and acquires state candidate qualitative expression information that qualitatively indicates a candidate for the state of the state estimation target portion. The estimation device acquires state candidate quantitative expression information that quantitatively indicates a candidate for the state of the state estimation target portion, based on the state candidate qualitative expression information.

### TECHNICAL FIELD

The present invention relates to an estimation device, an estimation method, and a recording medium.

### BACKGROUND ART

When estimating the state of a state monitoring target, such as a facility, simulation of the state monitoring target is used in some cases (for example, see Patent Document 1).

### PRIOR ART DOCUMENTS

### Patent Documents

Patent Document 1: Japanese Unexamined Patent Application, First Publication No. 2016-177676

### SUMMARY OF THE INVENTION

### Problems to be Solved by the Invention

When estimating input values to a simulation model such as sensor values, the number of input value candidates can become enormous. It is preferable that the number of candidate input values to a simulation model be relatively small.

An example object of the present invention is to provide an estimation device, an estimation method, and a recording medium capable of solving the problem mentioned above.

### Means for Solving the Problem

According to a first example aspect of the present invention, an estimation device includes: a qualitative inference means which determines a state estimation target portion of a monitoring target based on qualitative inference that uses designated portion qualitative expression information qualitatively indicating a state of a designated portion of the monitoring target, and acquires state candidate qualitative expression information that qualitatively indicates a candidate for the state of the state estimation target portion; and a quantitative state candidate setting means which acquires state candidate quantitative expression information that quantitatively indicates a candidate for the state of the state estimation target portion, based on the state candidate qualitative expression information.

According to a second example aspect of the present invention, an estimation method executed by a computer includes: determining a state estimation target portion of a monitoring target based on qualitative inference that uses designated portion qualitative expression information qualitatively indicating a state of a designated portion of the monitoring target, and acquiring state candidate qualitative expression information that qualitatively indicates a candidate for the state of the state estimation target portion; and acquiring state candidate quantitative expression information that quantitatively indicates a candidate for the state of the state estimation target portion, based on the state candidate qualitative expression information.

According to a third example aspect of the present invention, a recording medium has recorded therein a program causing a computer to execute: determining a state estimation target portion of a monitoring target based on qualitative inference that uses designated portion qualitative expression information qualitatively indicating a state of a designated portion of the monitoring target, and acquiring state candidate qualitative expression information that qualitatively indicates a candidate for the state of the state estimation target portion; and acquiring state candidate quantitative expression information that quantitatively indicates a candidate for the state of the state estimation target portion, based on the state candidate qualitative expression information.

### Effect of Invention

According to the estimation device, the estimation method, and the recording medium mentioned above, the number of candidates for input values to a simulation model can be relatively reduced.

### BRIEF DESCRIPTION OF THE DRAWINGS

FIG. 1 is a schematic block diagram showing an example of a functional configuration of an estimation device according to an example embodiment.

FIG. 2 is a diagram showing examples of state candidate qualitative expression information and state candidate quantitative expression information according to the example embodiment.

FIG. 3 is a flowchart showing an example of a processing procedure for the estimation device according to the example embodiment to estimate a factor candidate.

FIG. 4 is a schematic block diagram showing an example of a functional configuration in a case where the estimation device according to the example embodiment controls a monitoring target.

FIG. 5 is a diagram showing a configuration example of the estimation device according to the example embodiment.

FIG. 6 is a diagram showing an example of a processing procedure in an estimation method according to the example embodiment.

FIG. 7 is a schematic block diagram showing a configuration of a computer according to at least one example embodiment.

### EXAMPLE EMBODIMENT

Hereinafter, example embodiments of the present invention will be described, however, the present invention within the scope of the claims is not limited by the following example embodiments. Furthermore, all the combinations of features described in the example embodiments may not be essential for the solving means of the invention.

An estimation device according to the example embodiment receives designation of a state amount of a monitoring target portion, and estimates the state amount of the monitoring target portion that would be a factor of the designated state amount. The estimation device according to the example embodiment may control the monitoring target, based on the estimated state amount.

The monitoring target, to which the estimation device according to the example embodiment is applied, may be various things in which the states of a plurality of portions are quantitatively expressed and which have a correlative relationship with the state of a portion between at least some of the plurality of portions. For example, the monitoring target may be a single piece of device or a facility such as factory.

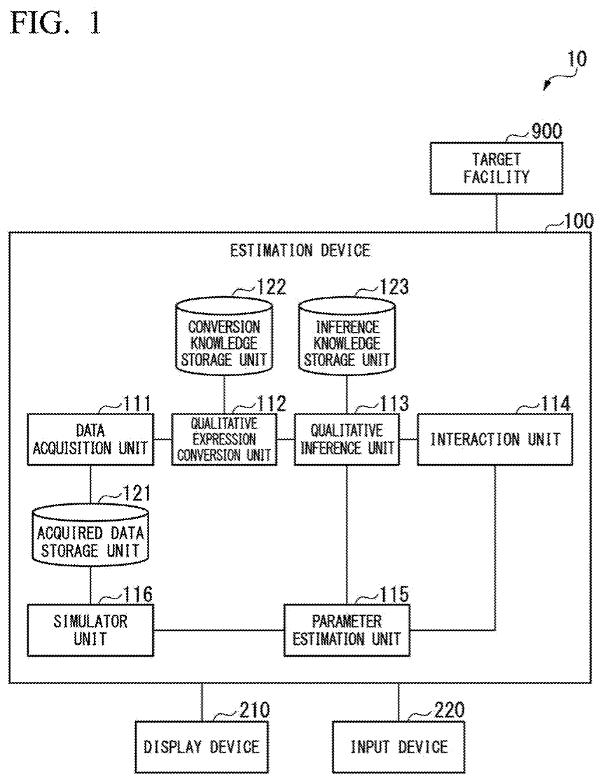

FIG. 1 is a schematic block diagram showing an example of a functional configuration of an estimation device according to the example embodiment. In the configuration shown in FIG. 1, an estimation system 10 includes an estimation device 100, a display device 210, and an input device 220.

The estimation device 100 includes a data acquisition unit 111, a qualitative expression conversion unit 112, a qualitative inference unit 113, an interaction unit 114, a parameter estimation unit 115, a simulator unit 116, an acquired data storage unit 121, a conversion knowledge storage unit 122, and an inference knowledge storage unit 123.

The display device 210 and the input device 220 may be configured as part of the estimation device 100. Moreover, the estimation device 100 acquires data such as sensor measurement data from a target facility 900.

The target facility 900 is a facility that is a target of state estimation performed by the estimation device 100. The target facility 900 can be various things either or both of the state and the behavior of which changes depending on the operation or the surrounding environment thereof or a combination of both. For example, the target facility 900 may be a plant (factory facility) or a single piece of device; however, is not limited to these.

In the following, there will be described an example of a case where the target facility 900 corresponds to an example of the monitoring target. The monitoring target referred to here is a target of state monitoring. A user can use the estimation device 100 to estimate the factor of the state detected through state monitoring.

However, a combination of the target facility 900 and the surrounding environment thereof may correspond to an example of the monitoring target. That is to say, when the influence of the surrounding environment on the target facility 900 cannot be ignored, or when the influence of the target facility 900 on the surrounding environment cannot be ignored, the estimation device 100 may take into consideration of not only the target facility 900 but also the surrounding environment thereof to perform state estimation.

For example, consider a case where an anomaly occurs in the target facility 900, and one of the factors thereof is the temperature of a room, in which the target facility 900 is installed, being high. In such a case, since room temperature is included in one of the events used by the estimation device 100 to perform state estimation, then when presenting estimated anomaly factor candidates to the user, the estimation device 100 is expected to be able to present them, inclusive of room temperature.

The factor referred to here is a thing that has an influence on a result. The factor may include a cause. The cause referred to here is a thing that has a direct influence on a result.

Upon receiving designation of a portion of the target facility 900 and input of information indicating a state of the portion, the estimation device 100 estimates candidates for factors that bring the designated portion into the state.

A portion of the target facility 900 that is designated for the estimation device 100 is also referred to as a designated portion. The state of the designated portion indicated by the above information, that is, the state designated for the designated portion is also referred to as designated state.

For example, when an anomaly occurs in the target facility 900, the estimation device 100 may estimate a candidate for the anomaly. Furthermore, for example, when a sensor value indicating an anomaly in the target facility 900 is acquired from the target facility 900, the estimation device 100 may estimate factor candidates for the anomaly.

When an anomaly occurs in the target facility 900, the estimation device 100 may estimate anomaly factor candidates.

Alternatively, the estimation device 100 may be used for predicting and preventing anomalies, and may receive an indication of an anomaly assumed to occur in the target facility 900 and estimate candidates for the factor that causes the anomaly.

As the indication of an anomaly assumed to occur in the target facility 900, for example, the user may input, to the estimation device 100, a location at which an anomaly is assumed to occur in the target facility 900 and an abnormal state assumed for the location. In such a case, the location at which an anomaly is assumed occur corresponds to an example of the designated portion. The abnormal state assumed for the location corresponds to an example of the designated state.

However, the application of the estimation device 100 is not limited to anomaly factor estimation. For example, the estimation device 100 may be used for purposes of quality control or energy saving.

The estimation device 100 may estimate candidates for the factor of deterioration in the state of a portion of the target facility 900 that does not quite result in an anomaly.

The estimation device 100 may receive an indication of a target value of the state of a portion of the target facility 900 and estimate candidates for an operation to be performed on the estimation device 100 to achieve the target value.

For example, the estimation device 100 may receive an input of a target value of the processing speed in a certain process of the target facility 900, and then estimate setting and operation candidates for the target facility 900 to achieve the target value.

Alternatively, the estimation device 100 may receive an input of a target value of the power consumption at a major power consumption location, such as a driving unit, of the target facility 900, and then estimate setting and operation candidates for the target facility 900 to achieve the target value.

The designated state may be input to the estimation device 100 in a quantitative expression, or may be input to the estimation device 100 in a qualitative expression.

The quantitative expression referred to here is an expression in a quantitative manner, that is, an expression using a numerical value. For example, in the case where the designated portion is a pipe, the rate of flow through the pipe may be indicated in a numerical value as a designated state.

The qualitative expression referred to here is an expression in a qualitative manner, that is, an expression that can be made without using a numerical value. For example, in the case where the designated portion is a shutoff valve, the open or closed state of the shutoff valve may be indicated as a designated state. However, a discrete numerical value may be used for the qualitative expression, such as “1” for the open state of the shutoff valve and “0” for the closed state.

Here, generally, it is not possible to obtain a model corresponding to the inverse function of a simulation model used in a simulator. Also, in the case where the estimation device 100 estimates the state of the target facility 900, it is usually not possible to calculate a factor by inputting a designated state into a model and analytically solving the model.

As a method of factor estimation using a simulator, there may be considered a method in which a plurality of input data sets for a simulation model are prepared and a simulation is performed for each input data set. In such a case, it is conceivable to select an input data set in which the state of the designated portion in the simulation result matches or is close to the designated state, as a factor candidate.

The closeness in this context is determined, for example, by making a comparison with a criterion for determining closeness. Furthermore, for example, it is conceivable to calculate the “distance” between the state amount of the designated portion in the simulation result and the designated state amount, and it is determined as being “close” if the calculated “distance” is equal to or shorter than a predetermined threshold value.

However, in those cases where the simulation model is complex, such as where the scale of the target facility 900 is large, the number of possible input data sets becomes enormous, and the simulation execution time for each input data set becomes long. For this reason, it is conceivable that estimation results cannot be obtained exhaustively within a realistic length of time.

Therefore, the estimation device 100 performs qualitative inference regarding the target facility 900 to narrow down the candidates for the factor of the designated state. For example, the estimation device 100 may estimate a combination of portions that affect the state of the designated portion, among the respective portions of the target facility 900. A combination of portions that affect the state of the designated portion, which is estimated by the estimation device 100, is also referred to as a state estimation target portion set. Individual portions included in the state estimation target portion set are also referred to as state estimation target portions.

It is conceivable that the inference result will differ depending on the inference rule selection or the inference rule application order selection when the estimation device 100 performs qualitative inference. Therefore, the estimation device 100 may perform qualitative inference regarding the target facility 900 multiple times, and determine the state estimation target portion set each time the qualitative inference is performed. It can be said that a single state estimation target portion set is a candidate for a combination of portions that cause the factor of the designated state. It can be said that a state estimation target portion is a candidate for a portion that causes the factor of the designated state.

In addition to estimation of the state estimation target portion, the estimation device 100 may further qualitatively estimate the state of the state estimation target portion. As a result, the estimation device 100 can further narrow down the candidates for the designated state factor. For example, the estimation device 100 may estimate whether the value of the valve opening or fluid flow rate in the state estimation target portion is higher than a reference value, equal to the reference value, or lower than the reference value.

The estimation device 100 generates an input data set for the simulation model, based on the result of refining factor candidates. The estimation device 100 may generate a plurality of input data sets to the simulation model. For example, the estimation device 100 may set a value consistent with the state qualitatively estimated by the qualitative inference for the state estimation target portion among the portions of the target facility 900, and set a predetermined reference value for the other portions, to generate an input data set to the simulation model.

The estimation device 100 then performs a simulation for each input data set and selects a data set based on the simulation result. For example, the estimation device 100 selects an input data set in which the state of the designated portion in the simulation result matches or approximates by a predetermined condition or more the designated state, as a candidate for the designated state factor.

The display device 210 includes, for example, a display screen such as a liquid crystal panel or an LED (light emitting diode) panel, and displays various types of images under control of the estimation device 100. For example, the display device 210 displays the state estimation result of the target facility 900 obtained by the estimation device 100.

In the case where the estimation device 100 narrows down candidates for the factor of a designated state using an observed value of a portion of the target facility 900, the display device 210 may display the observed value acquisition target portion. In such a case, the user may observe the state of the portion of the target facility 900 with reference to the display on the display device 210, and input the observed value to the estimation device 100.

The input device 220 includes, for example, an input device for obtaining user operations, such as a keyboard and a mouse. The input device 220 transmits information indicating the received user operation to the estimation device 100. For example, the input device 220 obtains a user operation to input an observed value of a portion of the target facility 900 and transmits information indicating the input observed value to the estimation device 100.

The data acquisition unit 111 acquires various data related to the target facility 900. For example, the data acquisition unit 111 acquires from the target facility 900 measurement data of a sensor provided in the target facility 900 and data indicating an operation performed on the target facility 900.

In the case where the monitoring target includes the surrounding environment of the target facility 900, the data acquisition unit 111 may also acquire measurement data of sensors installed around the target facility 900. Furthermore, the data acquisition unit 111 may also acquire data indicating operations performed on devices installed around the target facility 900, such as data indicating operations performed on an air conditioner in the room where the target facility 900 is installed.

The qualitative expression conversion unit 112 converts a quantitative expression into a qualitative expression. For example, the qualitative expression conversion unit 112 converts information representing a designated state in a quantitative expression into designated portion qualitative expression information. The qualitative expression conversion unit 112 corresponds to an example of the qualitative expression conversion means.

The designated portion qualitative expression information referred to here is information that qualitatively indicates the state of a designated portion. The designated portion qualitative expression information may include information that explicitly indicates the designated portion. Alternatively, the designated portion qualitative expression information itself may not explicitly indicate the designated portion, and the designated portion qualitative expression information may be used together with information indicating the designated portion.

The qualitative expression conversion unit 112 may compare the amount represented in a quantitative expression with a predetermined threshold value and convert it into a qualitative expression. For example, consider a case where information indicating the flow rate in a portion P1 of the target facility 900 is input to the qualitative expression conversion unit 112. In such a case, the qualitative expression conversion unit 112 may compare the flow rate in the portion P1 with each of an upper limit threshold value and a lower limit threshold value defined preliminarily for portion P1.

Then, if the flow rate in the portion P1 is determined as being higher than the upper limit threshold value, the qualitative expression conversion unit 112 may output qualitative expression information indicating “the flow rate in the portion P1 being high”. Moreover, if the flow rate in the portion P1 is determined as being equal to or lower than the upper limit threshold value and equal to or more than the lower limit threshold value, the qualitative expression conversion unit 112 may output qualitative expression information indicating “the flow rate in the portion P1 being normal”. Also, if the flow rate in the portion P1 is determined as being lower than the lower limit threshold value, the qualitative expression conversion unit 112 may output qualitative expression information indicating “the flow rate in the portion P1 being low”.

However, the number of threshold values used by the qualitative expression conversion unit 112 for conversion from a quantitative expression to a qualitative expression is not limited to two, and may be any number equal to or greater than one.

For example, the qualitative expression conversion unit 112 may compare the flow rate in the portion P1 with one threshold value. In such a case, if the flow rate in the portion P1 is determined as being higher than the threshold value, the qualitative expression conversion unit 112 may output qualitative expression information indicating “the flow rate in the portion P1 being high”. Also, if the flow rate in the portion P1 is determined as being equal to or lower than the threshold value, the qualitative expression conversion unit 112 may output qualitative expression information indicating “the flow rate in the portion P1 being low”.

The qualitative inference unit 113 performs qualitative inference using designated portion qualitative expression information. The qualitative inference performed by the qualitative inference unit 113 is also referred to as qualitative inference regarding the target facility 900. Based on this inference, the qualitative inference unit 113 determines the state estimation target portion of the target facility 900 and acquires state candidate qualitative expression information. The qualitative inference unit 113 corresponds to an example of the qualitative inference means.

The state candidate qualitative expression information referred to here is information that qualitatively represents the state of the state estimation target portion. The state candidate qualitative expression information may include information that explicitly indicates the portion of the target facility 900. Alternatively, the state candidate qualitative expression information itself may not explicitly indicate the portion of the target facility 900, and the state candidate qualitative expression information may be used together with information indicating the portion of the target facility 900.

The qualitative inference unit 113 may concurrently perform determination of the state estimation target portion and acquisition of the state candidate qualitative expression information. For example, the qualitative inference unit 113 may acquire the state candidate qualitative expression information of all the state estimation target portions included in the state estimation target portion set by means of qualitative inference, and each state candidate qualitative expression information may include information that indicates the state estimation target portion.

Inference rules for qualitative inference performed by the qualitative inference unit 113 include an inference rule of receiving an input of the qualitative expression of the state of one or more portions of the target facility 900, and then outputting a qualitative expression of the state of one or more portions of the target facility 900.

In the case where an input to a certain inference rule corresponds to a factor and an output of the inference rule corresponds to a result, the qualitative inference unit 113 may perform backward inference, using the inference rule. Also, in the case where an input to a certain inference rule corresponds to a result and an output of the inference rule corresponds to a factor, the qualitative inference unit 113 may perform forward inference, using the inference rule.

The qualitative inference unit 113 applies an inference rule to the designated portion qualitative expression information one or more times in one qualitative inference, and acquires one state estimation target portion set and the state candidate qualitative expression information of each portion indicated by the state estimation target portion set.

As described above regarding the estimation device 100, the qualitative inference unit 113 may perform qualitative inference regarding the target facility 900 multiple times, and determine the state estimation target portion set each time qualitative inference is executed.

The inference rules for qualitative inference performed by the qualitative inference unit 113 may include an inference rule where a state for each of input and output is arbitrary state. Arbitrariness here is a so-called wild card. The qualitative inference unit 113 can estimate the state estimation target portion, using this inference rule.

Information that indicates one piece of state candidate qualitative expression information for each of all state estimation target portions included in one state estimation target portion set is also referred to as a hypothesis. An inference rule may be defined so that the qualitative inference unit 113 acquires one hypothesis by executing qualitative inference once.

Alternatively, the qualitative inference unit 113 may acquire a plurality of hypotheses by executing qualitative inference once. For example, the qualitative inference unit 113 may acquire an inference result including information that indicates whether the opening of an adjustment valve is “normal” or “large” by executing qualitative inference once. The qualitative inference unit 113 may then acquire a hypothesis that includes information indicating that the opening of the adjustment valve is “normal” and a hypothesis that includes information indicating that the opening of the adjustment valve is “large.”

The parameter estimation unit 115 acquires state candidate quantitative expression information that quantitatively indicates a candidate for the state of the state estimation target portion, on the basis of the state candidate qualitative expression information. The parameter estimation unit 115 corresponds to an example of the quantitative state candidate setting means.

For example, the parameter estimation unit 115 may replace the qualitative expression of the state amount in the state candidate qualitative expression information with information on a range that the state amount can take, and sample the state amount within the obtained range.

Furthermore, for example, consider a case where the state candidate qualitative expression information indicates that the opening of an adjustment valve P2 is large, and the upper limit threshold value for the opening of the adjustment valve P2 is set at 60%. It is also assumed that the sampling interval of the opening of the adjustment valve P2 is set at 5%.

In such a case, the parameter estimation unit 115 calculates that the range of the opening of the adjustment valve P2 is greater than 60% and less than or equal to 100%. Here, the 100% opening of the adjustment valve P2 is the maximum opening of the adjustment valve P2.

The parameter estimation unit 115 sets the opening of the adjustment valve P2 for each sampling interval within the range of the obtained opening, such as 65%, 70%, 75%, . . . , 100%.

Each opening set by the parameter estimation unit 115 is treated as a candidate for the opening of the adjustment valve P2. The candidates are narrowed down based on the simulation result of the operation of the target facility 900 performed by the simulator unit 116.

Alternatively, the parameter estimation unit 115 may set the probability distribution of the state amount of the state estimation target portion, based on the state candidate qualitative expression. The parameter estimation unit 115 may then acquire the state candidate quantitative expression information by sampling the state amount of the state estimation target portion according to the set probability distribution.

In such a case, the parameter estimation unit 115 may set the state amount of the state estimation target portion only within the range of the state amount of the state estimation target portion calculated from the state candidate qualitative expression information and the threshold value. Alternatively, the parameter estimation unit 115 may also set the state amount of the state estimation target portion outside the range of the state amount of the state estimation target portion calculated from the state candidate qualitative expression information and the threshold value, according to the probability distribution.

By converting a qualitative expression included in a hypothesis into a quantitative expression, the parameter estimation unit 115 can obtain information that quantitatively indicates the candidate of the factor of the designated state. The information obtained by converting a qualitative expression included in a hypothesis into a quantitative expression is referred to as a quantitative hypothesis.

However, the state of all state estimation target portions included in a quantitative hypothesis need not be indicated in a quantitative expression. For example, in the case where the state of a state estimation target portion is a qualitative state, such as when the state estimation target portion is a shutoff valve, the parameter estimation unit 115 leaves the information indicating the state of the state estimation target portion to remain being state candidate qualitative expression information.

A quantitative hypothesis can be defined, for example, as information in which one or more qualitative expressions included in a hypothesis are converted into quantitative expressions. Also, it can be said that a quantitative hypothesis is information that indicates one piece of state candidate quantitative expression information for each of all state estimation target portions included in one state estimation target portion set.

The simulator unit 116 narrows down state candidate quantitative expression information, based on a comparison between the state of a designated portion in the result of a simulation of the target facility 900 using state candidate quantitative expression information, and a designated state. The simulator unit 116 corresponds to an example of the simulator means.

For example, the simulator unit 116 generates an input data set to a simulation model, for each quantitative hypothesis generated by the parameter estimation unit 115. Specifically, for a portion indicating a state in a quantitative hypothesis among portions of the target facility 900, the simulator unit 116 uses information indicating the state as input data to the simulator model. For other portions, the simulator unit 116 may set predetermined reference values, and generate input data sets to the simulation model.

The simulator unit 116 then simulates the target facility 900 for each generated input data set to calculate the state of the designated portion.

The simulator unit 116 selects the quantitative hypothesis that is the origin of an input data set in which the state of the designated portion in the simulation result matches or approximates by a predetermined condition or more the designated state, as a candidate for the designated state factor. That is to say, when the state of the designated portion in the simulation result matches or approximates by the predetermined condition or more the designated state, the simulator unit 116 selects the quantitative hypothesis used in the simulation as a candidate for the designated state factor.

The candidate for the designated state factor acquired by the simulator unit 116 corresponds to information obtained by extracting state information of each portion of the state estimation target portion set from the input data set, in which the state of the designated portion in the simulation result matches or approximates by the predetermined condition or more the designated state. Selecting some of a plurality of quantitative hypotheses by the simulator unit 116 as candidates for the factor of the designated state corresponds to an example of refining the state candidate quantitative expressions described above.

The interaction unit 114 narrows down at least one of state candidate qualitative expression information and state candidate quantitative expression information, using information indicating the observed value of the state of the state estimation target portion. The information indicating the observed value of the state of the state estimation target portion is also referred to as observed value information. The interaction unit 114 corresponds to an example of the observed value reflection means.

For example, the interaction unit 114 may cause the display device 210 to display a state estimation target portion. The user may then actually observe, in the target facility 900, the state of the displayed state estimation target portion, and input the obtained observed value information to the estimation device 100, using the input device 220. The state observed by the user may be a quantitative state such as the opening of an adjustment valve, or a qualitative state such as opening or closing of a shutoff valve.

The interaction unit 114 can make reference to the observed value information to narrow down the state candidate qualitative expression information. Specifically, the interaction unit 114 may delete, from hypotheses obtained through qualitative inference of the qualitative inference unit 113, hypotheses that include state candidate qualitative expression information that is inconsistent with the observed value information.

For example, consider a case where the target facility 900 includes a cooling tower and the qualitative inference unit 113 has generated a hypothesis H1 that includes “cooling tower outdoor air temperature is high” and a hypothesis H2 that includes “cooling tower fan's intake air volume is low”. The “cooling tower outdoor air temperature is high” and the “cooling tower fan's intake air volume is low” are both examples of the state candidate qualitative expression information.

In such a case, the display device 210, according to an instruction from the interaction unit 114, may display the state estimation target portion of the “cooling tower outdoor air temperature” or the state candidate qualitative expression information of the “cooling tower outdoor air temperature is high”.

Furthermore, consider a case where the user who has made reference to the display of the display device 210 measures the outdoor air temperature of the cooling tower, and inputs “cooling tower outdoor air temperature is 20° C.” as the observed value information, using the input device 220. In such a case, the qualitative expression conversion unit 112 converts the observed value information into a qualitative expression, so that the interaction unit 114 can determine whether or not the hypothesis H1 is consistent with the measurement value information.

If “cooling tower outdoor air temperature is 20° C.” is converted into a qualitative expression indicating that “cooling tower outdoor air temperature is normal”, the hypothesis including the state candidate qualitative expression information indicating that “cooling tower outdoor air temperature is high” is not consistent with the observed value information. In such a case, the interaction unit 114 can delete the hypothesis H1 as an error. Deletion of a hypothesis performed by the interaction unit 114 corresponds to an example of the refining of state candidate qualitative expression information.

Alternatively, the interaction unit 114 may make reference to the observed value information and narrow down the state candidate quantitative expression information. For example, the interaction unit 114 may delete, from the quantitative hypotheses calculated by the parameter estimation unit 115, quantitative hypotheses that include state candidate quantitative expression information that is not consistent with the observed value information.

The interaction unit 114 may calculate the difference between the state information of the designated portion included in the quantitative hypothesis and the observed value of the state of the designated portion, and if the magnitude of the difference is greater than a predetermined threshold value, the interaction unit 114 may delete the quantitative hypothesis as it is inconsistent with the observed value. Deletion of a quantitative hypothesis performed by the interaction unit 114 corresponds to an example of the refining of state candidate quantitative expression information.

Alternatively, while the display device 210 is not displaying an estimation target portion, the user may observe the state of the portion of the target facility 900 and input the observed value information to the estimation device 100, using the input device 220. In this case also, the interaction unit 114 can narrow down the candidate qualitative expression information or state candidate quantitative expression information in the same manner as in the above case.

The acquired data storage unit 121 stores data used for simulation, such as data acquired by the data acquisition unit 111.

The conversion knowledge storage unit 122 stores various information used for conversion from quantitative expression to qualitative expression. For example, the conversion knowledge storage unit 122 stores a threshold value to be compared with the amount indicated in a quantitative expression when the qualitative expression conversion unit 112 converts a quantitative expression into a qualitative expression.

The inference knowledge storage unit 123 stores various data used for qualitative inference performed by the qualitative inference unit 113, such as inference rules for qualitative inference.

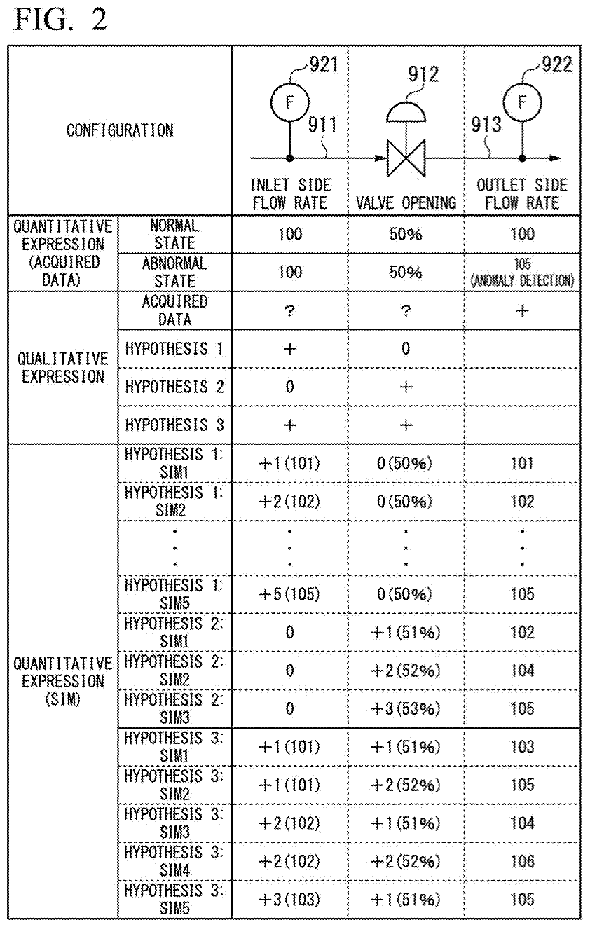

FIG. 2 is a diagram showing examples of state candidate qualitative expression information and state candidate quantitative expression information.

In FIG. 2, a flow rate meter 921 is provided on a pipe 911 on the inlet side of an adjustment valve 912, and a flow rate meter 922 is provided on a pipe 913 on the outlet side.

With this configuration, in a normal steady state, the flow rate on the inlet side measured by the flow rate meter 921 and the flow rate on the outlet side measured by the flow rate meter 922 are both 100, and the opening of the adjustment valve 912 is 50%. Assume that an anomaly is detected in which the flow rate on the outlet side measured by the flow rate meter 922 increases to 105.

The qualitative expression “+” in the acquired data indicates a state in which the flow rate on the outlet side is higher than the normal state value. “?” indicates that it has been determined as a state estimation target portion.

Hypothesis 1, hypothesis 2, and hypothesis 3 show examples of state candidate qualitative expression information. As a result of qualitative inference, the qualitative inference unit 113 acquires three candidates as factor candidates, namely, inlet side flow rate “+” and valve opening “0” (hypothesis 1), inlet side flow rate “0” and valve opening “+” (Hypothesis 2), and inlet side flow rate “+” and valve opening “+” (Hypothesis 3).

For hypothesis 1, the parameter estimation unit 115 sets five factor candidates, namely, inlet side flow rate “101” and valve opening “50%” (hypothesis 1: SIM1), inlet side flow rate “102” and valve opening “50%” (hypothesis 1: SIM2), inlet side flow rate “103” and valve opening “50%” (hypothesis 1: SIM3), inlet side flow rate “104” and valve opening “50%” (hypothesis 1: SIM4), and inlet side flow rate “105” and valve opening “50%” (hypothesis 1: SIM5).

Also, for hypothesis 2, the parameter estimation unit 115 sets three factor candidates, namely, inlet side flow rate “100” and valve opening “51%” (hypothesis 2: SIM1), inlet side flow rate “100” and valve opening “52%” (hypothesis 2: SIM2), and inlet side flow rate “100” and valve opening “53%” (hypothesis 3: SIM1).

Moreover, for hypothesis 3, the parameter estimation unit 115 sets five factor candidates, namely, inlet side flow rate “101” and valve opening “51%” (hypothesis 3: SIM1), inlet side flow rate “101” and valve opening “52%” (hypothesis 3: SIM2), inlet side flow rate “102” and valve opening “51%” (hypothesis 3: SIM3), inlet side flow rate “102” and valve opening “52%” (hypothesis 3: SIM4), and inlet side flow rate “103” and valve opening “51%” (hypothesis 3: SIM5).

The parameter estimation unit 115 performs a simulation, using each of the set factor candidates. As a result of the simulation, the outlet side flow rate in the outlet side pipe 913, which corresponds to the example of the state of the designated portion, takes the same measurement value “105” in each of inlet side flow rate “105” and valve opening “50%” (hypothesis 1: SIM5), inlet side flow rate “100” and valve opening “53%” (hypothesis 2: SIM3), inlet side flow rate “101” and valve opening “52%” (hypothesis 3: SIM2), and inlet side flow rate “103” and valve opening “51%” (hypothesis 3: SIM5). The parameter estimation unit 115 takes these as factor candidates.

Furthermore, based on hypothesis 3: SIM3 (simulation result, outlet side flow rate “104”) and hypothesis 3: SIM4 (simulation result, outlet side flow rate “106”), the parameter estimation unit 115 may generate a factor candidate of inlet side flow rate “102” and valve opening “51.5%”.

For example, regarding hypothesis 3: the valve opening “51%” of SIM3 and hypothesis 3: the valve opening “52%” of SIM4, the parameter estimation unit 115 may perform linear interpolation with a ratio according to the difference between the simulation result and the measured value of the outlet side flow rate. The parameter estimation unit 115 performs linear interpolation, for example, as shown in Equation (1) to calculate the valve opening “51.5%” as a factor candidate.

$$\begin{matrix}[ Math . 1 ] & \\ 51 \times \frac{106 - 105}{106 - 104} + 52 \times \frac{104 - 105}{104 - 106} = 51.5 & ( 1 )\end{matrix}$$

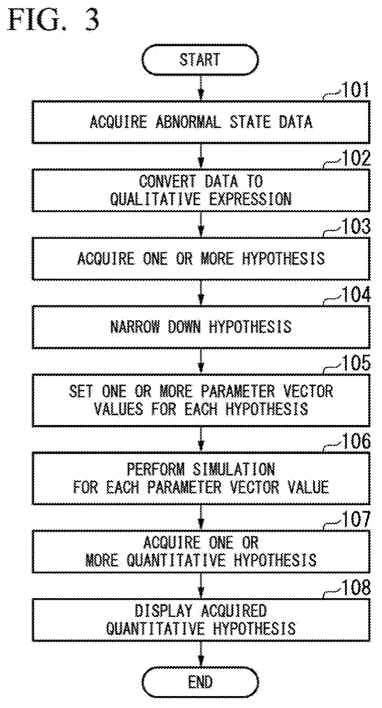

FIG. 3 is a flowchart showing an example of a processing procedure for the estimation device 100 to estimate a factor candidate.

In the processing of FIG. 3, the data acquisition unit 111 acquires abnormal state data (Step S101). The abnormal state data here corresponds to an example of the designated state. The data acquisition unit 111 may acquire a sensor value indicating an anomaly from a sensor provided in the target facility 900 as the abnormal state data. Alternatively, for example, the user may input information indicating a designated portion and a designated state, using the input device 220, and the data acquisition unit 111 may acquire the input information as the abnormal state data.

However, as described above, the designated state is not limited to an abnormal state.

Next, the qualitative expression conversion unit 112 converts the abnormal state data acquired by the data acquisition unit 111 into qualitative expression data (Step S102). The data obtained by the qualitative expression conversion unit 112 by converting the abnormal state data corresponds to an example of designated portion qualitative expression information.

Next, the qualitative inference unit 113 acquires one or more hypotheses (Step S103). Specifically, the qualitative inference unit 113 performs qualitative inference by applying inference rules to the converted data performed by the qualitative expression conversion unit 112, and obtains the hypotheses. As described above, an inference rule may be defined so that one hypothesis can be obtained by performing qualitative inference once. Then, the qualitative inference unit 113 may obtain a plurality of hypotheses by performing qualitative inference a plurality of times.

Next, the interaction unit 114 narrows down the hypotheses (Step S104). As described above, the interaction unit 114 acquires observed value information indicating the observed value of the state of the state estimation target portion. Then, the interaction unit 114 narrows down the hypotheses by refining at least one of state candidate qualitative expression information or state candidate quantitative expression information that is not consistent with the obtained observed value information.

Next, the parameter estimation unit 115 replaces the qualitative expression included in a hypothesis with a quantitative expression to generate a quantitative hypothesis (Step S105). The parameter estimation unit 115 may generate a plurality of quantitative hypotheses based on one hypothesis.

Next, the simulator unit 116 executes a simulation for each quantitative hypothesis generated by the parameter estimation unit 115 (Step S106). As described above, the simulator unit 116 generates an input data set to the simulation model for each quantitative hypothesis. For example, the simulator unit 116 sets a predetermined reference value for items not indicated in the quantitative hypothesis among input items to the simulation model, to thereby expand the quantitative hypothesis and generate an input data set.

The simulator unit 116 then executes a simulation for each generated input data set.

Next, the simulator unit 116 selects one or more of the quantitative hypotheses as factor candidates for the designated state based on the simulation results (Step S107). As described above, when the state of the designated portion in the simulation result matches or approximates by a predetermined condition or more the designated state, the simulator unit 116 selects the quantitative hypothesis used in the simulation as a candidate for the designated state factor.

Then, the interaction unit 114 causes the display device 210 to display factor candidates for the designated state (Step S108). In the case where the simulator unit 116 selects a plurality of quantitative hypotheses as factor candidates for the designated state, the interaction unit 114 may cause the display device 210 to display each of the plurality of quantitative hypotheses.

However, the method for the estimation device 100 to output factor candidates for the designated state is not limited to the method of displaying on the display device 210. For example, the estimation device 100 may transmit factor candidates for the designated state to another device.

Moreover, the estimation device 100 may control the target facility 900, using the factor candidates for the designated state.

After Step S108, the estimation device 100 ends the processing of FIG. 3.

As described above, the qualitative inference unit 113 determines a state estimation target portion of the target facility 900 on the basis of qualitative inference that uses designated portion qualitative expression information qualitatively indicating the state of the designated portion of the target facility 900, and acquires state candidate qualitative expression information that qualitatively indicates a candidate for the state of the state estimation target portion. The parameter estimation unit 115 acquires state candidate quantitative expression information that quantitatively indicates a candidate for the state of the state estimation target portion, on the basis of the state candidate qualitative expression information.

The qualitative inference unit 113 performs qualitative inference using the designated portion qualitative expression information, so that the candidates for the state of the state estimation target portion can be narrow down. Also, the qualitative inference unit 113 performs qualitative inference, and in this respect, the amount of calculation is expected to be smaller than that in the case of refining candidates for the state of the state estimation target portion by quantitative calculation.

In this way, according to the estimation device 100, the number of candidates for input values to the simulation model can be relatively reduced. For example, the estimation device 100 can narrow down candidates for input values to the simulation model more than compared with the case of randomly setting candidates for input values to the simulation model without performing qualitative inference.

Moreover, with the estimation device 100 quantitatively indicating the state of the state estimation target portion or candidate thereof, it is possible to present to the user not only the location of the anomaly but also the degree of the anomaly. After having made reference to the estimation result of the estimation device 100, the user can recognize that, for example, when an abnormal value with a minute difference from the normal value is shown, the state of the anomaly location needs to be observed carefully.

Furthermore, the simulator unit 116 narrows down state candidate quantitative expression information, based on a comparison between the result of a simulation of the target facility 900 using state candidate quantitative expression information, and the state of the designated state.

Here, the state candidate quantitative expression information acquired by the parameter estimation unit 115 can also be regarded as information indicating candidate factors of the state of the designated portion. According to the simulator unit 116, it is possible to narrow down the candidate factors of the state of the designated portion indicated by the state candidate quantitative expression information.

Also, the qualitative expression conversion unit 112 converts information quantitatively indicating the state of the designated portion, into designated portion qualitative expression information.

With the qualitative expression conversion unit 112 performing such conversion, the qualitative inference unit 113 can perform qualitative inference.

Also, the interaction unit 114 narrows down at least one of state candidate qualitative expression information or state candidate quantitative expression information, using observed value information indicating the observed value of the state of some state estimation target portions among a plurality of state estimation target portions.

As a result, the number of simulations performed by the simulator unit 116 can be reduced, and the load on the simulator unit 116 is relatively reduced.

As described above, the estimation device may control the monitoring target, using candidate factors of the designated state.

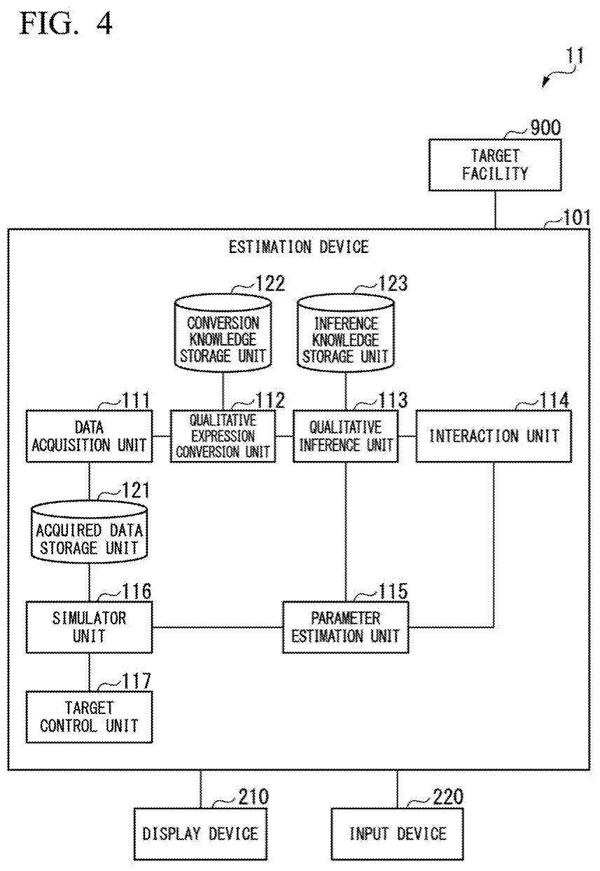

FIG. 4 is a schematic block diagram showing an example of a functional configuration in a case where the estimation device controls the monitoring target. In the configuration shown in FIG. 4, an estimation system 11 includes an estimation device 101, a display device 210, and an input device 220.

The estimation device 101 includes the data acquisition unit 111, the qualitative expression conversion unit 112, the qualitative inference unit 113, the interaction unit 114, the parameter estimation unit 115, the simulator unit 116, a target control unit 117, the acquired data storage unit 121, the conversion knowledge storage unit 122, and the inference knowledge storage unit 123.

Of the constituents shown in FIG. 4, ones corresponding to those in FIG. 1 and having the similar functions are given the same reference signs (111, 112, 113, 114, 115, 116, 121, 122, 123, 210, 220, 900), and detailed descriptions thereof are omitted.

In the estimation system 11, the estimation device 101 further includes the target control unit 117 in addition to the configuration of the estimation device 100. In other respects, the estimation system 11 is similar to the estimation system 10.

The target control unit 117 controls the target facility 900 based on state candidate quantitative expression information. Specifically, the target control unit 117 controls the target facility 900, based on quantitative hypotheses as candidate factors of a designated state.

The target control unit 117 corresponds to an example of the target control means.

In the case where a target value of the state amount of a designated portion is indicated as a designated state, the target control unit 117 may control the target facility 900 so that the state of the state estimation target portion is brought to the state indicated by the candidate factor of the designated state. Thereby, the target control unit 117 controls the target facility 900 so that the state amount of the designated portion approaches the target value.

In the case where an anomaly occurs in the target facility 900 and an abnormal value of the state amount of the designated portion is indicated as a designated state, for example, the simulator unit 116 may search for the state amount of the state estimation target portion so that the state amount of the designated portion approaches the normal value.

For example, the simulator unit 116 may change the state amount of the state estimation target portion from the state amount indicated in the quantitative hypothesis to execute a simulation, and may employ the state amount of the state estimation target portion such that the state amount of the designated portion approaches the normal value.

Then, the target control unit 117 may control the target facility 900 so as to bring the state amount of the state estimation target portion to the state amount employed by the simulator unit 116. Thereby, the target control unit 117 controls the target facility 900 so that the state amount of the designated portion of the target facility 900 approaches the normal value.

In the case where a plurality of quantitative hypotheses have been obtained as factor candidates for the designated state, the user may select any one of the plurality of quantitative hypotheses. Then, the target control unit 117 may control the target facility 900 based on the selected quantitative hypothesis.

Alternatively, instead of the user, the estimation device 101 may select any one of the plurality of quantitative hypotheses. For example, the target control unit 117 may randomly select any one of the plurality of quantitative hypotheses.

Alternatively, the target control unit 117 may calculate a value that integrates a plurality of quantitative hypotheses, such as averaging the state amounts indicated by the plurality of quantitative hypotheses for each state estimation target portion. Then, the target control unit 117 may control the target facility 900 based on the calculated value.

As described above, the target control unit 117 controls the target facility 900 based on state candidate quantitative expression information. As a result, the target control unit 117 can control the target facility 900 so that the designated state, which is a state of the designated portion of the target facility 900, approaches the desired state.

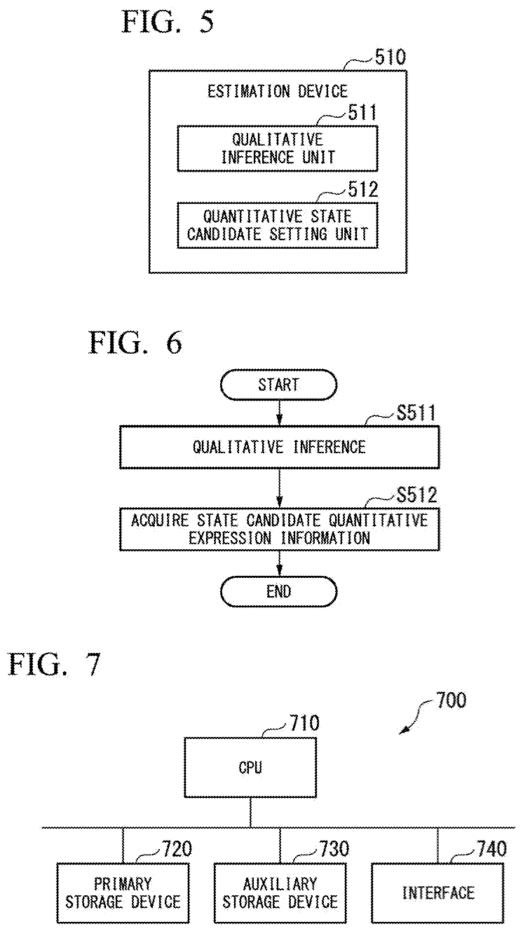

FIG. 5 is a diagram showing a configuration example of the estimation device according to the example embodiment. With the configuration shown in FIG. 5, an estimation device 510 includes a qualitative inference unit 511 and a quantitative state candidate setting unit 512.

In such a configuration, the qualitative inference unit 511 determines a state estimation target portion of a monitoring target on the basis of qualitative inference that uses designated portion qualitative expression information qualitatively indicating the state of a designated portion of the monitoring target, and acquires state candidate qualitative expression information that qualitatively indicates a candidate for the state of the state estimation target portion. The quantitative state candidate setting unit 512 acquires state candidate quantitative expression information that quantitatively indicates a candidate for the state of the state estimation target portion, on the basis of the state candidate qualitative expression information.

The qualitative inference unit 511 corresponds to an example of the qualitative inference means. The quantitative state candidate setting unit 512 corresponds to an example of the quantitative state candidate setting means.

The qualitative inference unit 511 performs qualitative inference using the designated portion qualitative expression information, so that the candidates for the state of the state estimation target portion can be narrows down. In this way, according to the estimation device 510, the number of candidates for input values to the simulation model can be relatively reduced. For example, the estimation device 510 can narrow down candidates for input values to the simulation model more than compared with the case of randomly setting candidates for input values to the simulation model without performing qualitative inference.

The qualitative inference unit 511 can be realized, using the functions of the qualitative inference unit 113 shown in FIG. 1 and the like, for example. The quantitative state candidate setting unit 512 can be realized, using, the functions of the parameter estimation unit 115 in FIG. 1 and the like, for example.

FIG. 6 is a diagram showing an example of a processing procedure in an estimation method according to the example embodiment. The method shown in FIG. 6 includes a step of performing qualitative inference (Step S511) and a step of acquiring state candidate quantitative expression information (Step S512).

In the step of performing qualitative inference (Step S511), a state estimation target portion of a monitoring target is determined on the basis of qualitative inference that uses designated portion qualitative expression information qualitatively indicating the state of a designated portion of the monitoring target, and state candidate qualitative expression information that qualitatively indicates a candidate for the state of the state estimation target portion is acquired. In the step of acquiring state candidate quantitative expression information (Step S512), state candidate quantitative expression information that quantitatively indicates a candidate for the state of the state estimation target portion is acquired, on the basis of the state candidate qualitative expression information.

In the step of performing qualitative inference, by performing qualitative inference using the designated portion qualitative expression information, the candidates for the state of the state estimation target portion can be narrows down. In this way, according to the estimation method of FIG. 6, the number of candidates for input values to the simulation model can be relatively reduced. For example, according to the estimation method of FIG. 6, candidates for input values to the simulation model can be narrow down more than compared with the case of randomly setting candidates for input values to the simulation model without performing qualitative inference.

The process of Step S511 can be performed using, for example, the function of the qualitative inference unit 113 shown in FIG. 1 and the like. The process of Step S512 can be performed, for example, using the function of the parameter estimation unit 115 shown in FIG. 1 and the like.

FIG. 7 is a schematic block diagram showing a configuration of a computer according to at least one example embodiment.

In the configuration shown in FIG. 7, a computer 700 includes a CPU 710, a primary storage device 720, an auxiliary storage device 730, and an interface 740.

One or more of the estimation device 100 and the estimation device 510 or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 reserves, according to the program, storage regions corresponding to the respective storage units mentioned above, in the primary storage device 720. Communication between each device and other devices is executed by the interface 740 having a communication function and communicating according to the control of the CPU 710.

In the case where the estimation device 100 is implemented in the computer 700, operations of the qualitative expression conversion unit 112, the qualitative inference unit 113, the parameter estimation unit 115, and the simulator unit 116 are stored in the form of a program in the auxiliary storage device 730. The CPU 710 reads out the program from the auxiliary storage device 730, loads it on the primary storage device 720, and executes the processing described above according to the program.

Moreover, the CPU 710 reserves storage areas corresponding to the acquired data storage unit 121 and the inference knowledge storage unit 123, in the primary storage device 720 according to the program.

Data acquisition performed by the data acquisition unit 111 is executed, for example, by the interface 740 having a communication function, operating under the control of the CPU 710, and receiving data from the state estimation target.

Acquisition of observed value information performed by the interaction unit 114 is performed, for example, by the interface 740 having an input device such as a keyboard and receiving a user operation for inputting observed value information. Alternatively, the interface 740 may have a communication function, operate under the control of the CPU 710, and receive observed value information transmitted by the user using a terminal device.

The display of a quantitative description performed by the interaction unit 114 is executed by the interface 740 having a display screen and displaying the quantitative description on the display screen under the control of the CPU 710.

In the case where the estimation device 510 is implemented in the computer 700, operations of the qualitative inference unit 511 and the quantitative state candidate setting unit 512 are stored in the auxiliary storage device 730 in the form of a program. The CPU 710 reads out the program from the auxiliary storage device 730, loads it on the primary storage device 720, and executes the processing described above according to the program.

Also, the CPU 710 reserves a storage region in the primary storage device 720 for the processing to be performed by the estimation device 510 according to the program.

Communication with another device performed by the estimation device 510 is executed by the interface 740 having a communication function and operating under the control of the CPU 710.

Interaction between the estimation device 510 and the user is performed by, for example, the interface 740 having a display screen and displaying various images under the control of the CPU 710, and the interface 740 having an input device such as a keyboard and obtaining user operations.

It should be noted that a program for executing some or all of the processes performed by the estimation device 100 and the estimation device 510 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the example embodiments, and may include designs and so forth that do not depart from the scope of the present invention.

### DESCRIPTION OF REFERENCE SIGNS

10 Estimation system
100, 510 Estimation device
111 Data acquisition unit
112 Qualitative expression conversion unit
113, 511 Qualitative inference unit
114 Interaction unit
115 Parameter estimation unit
116 Simulator unit
121 Acquired data storage unit
123 Inference knowledge storage unit
512 Quantitative state candidate setting unit
900 Target facility

What is claimed is:

1. An estimation device comprising:
a memory configured to store instructions; and
a processor configured to execute the instructions to:
determine a state estimation target portion of a monitoring target based on qualitative inference that uses designated portion qualitative expression information qualitatively indicating a state of a designated portion of the monitoring target, and acquire state candidate qualitative expression information that qualitatively indicates a candidate for the state of the state estimation target portion; and
acquire state candidate quantitative expression information that quantitatively indicates a candidate for the state of the state estimation target portion, based on the state candidate qualitative expression information.

2. The estimation device according to claim 1, wherein the processor is configured to execute the instructions to:
narrow down the state candidate quantitative expression information based on a comparison between: the state of the designated portion in a simulation result of the monitoring target using the state candidate quantitative expression information; and a designated state of the designated portion.

3. The estimation device according to claim 1, wherein the processor is configured to execute the instructions to:
convert information quantitatively indicating the state of the designated portion, into the designated portion qualitative expression information.

4. The estimation device according to claim 1, wherein the processor is configured to execute the instructions to:
narrow down at least one of the state candidate qualitative expression information and the state candidate quantitative expression information, using observed value information indicating an observed value of the state of the state estimation target portion.

5. The estimation device according to claim 1, wherein the processor is configured to execute the instructions to:
control the monitoring target, based on the state candidate quantitative expression information.

6. An estimation method executed by a computer, comprising:
determining a state estimation target portion of a monitoring target based on qualitative inference that uses designated portion qualitative expression information qualitatively indicating a state of a designated portion of the monitoring target, and acquiring state candidate qualitative expression information that qualitatively indicates a candidate for the state of the state estimation target portion; and
acquiring state candidate quantitative expression information that quantitatively indicates a candidate for the state of the state estimation target portion, based on the state candidate qualitative expression information.

7. A non-transitory recording medium having recorded therein a program causing a computer to execute:
determining a state estimation target portion of a monitoring target based on qualitative inference that uses designated portion qualitative expression information qualitatively indicating a state of a designated portion of the monitoring target, and acquiring state candidate qualitative expression information that qualitatively indicates a candidate for the state of the state estimation target portion; and
acquiring state candidate quantitative expression information that quantitatively indicates a candidate for the state of the state estimation target portion, based on the state candidate qualitative expression information.
